(19) United States
(12) Patent Application Publication
(10) Pub. No.: US 2020/0208631 A1
(43) Pub. Date: Jul. 2, 2020

(54) ELECTRIC OIL PUMP

(71) Applicant: Nidec Tosok Corporation, Zama-shi, Kanagawa (JP)

(72) Inventors: Shigehiro KATAOKA, Zama-shi (JP); Yoshiyuki KOBAYASHI, Zama-shi (JP)

(21) Appl. No.: 16/633,601

(22) PCT Filed: Aug. 16, 2018
(86) PCT No.: PCT/JP2018/030398

§ 371 Date: Jan. 24, 2020

(30) Foreign Application Priority Data
Aug. 31, 2017 (JP) 2017-167828

(51) Int. Cl. F04C 15/00; F04C 13/00; H02K 3/52; H02K 7/14; H02K 11/33; H02K 21/16

(52) U.S. Cl. CPC F04C 15/0057; F04C 13/001; H02K 3/522; H02K 7/14; H02K 11/33; H02K 2207/03; F04C 2210/206; F04C 2240/40; F04C 2240/30; H02K 2203/06; H02K 21/16

(57) ABSTRACT

An electric oil pump includes a motor including a shaft, a pump driven via the shaft, and an inverter on a rear side of the motor and fixed to the motor. The motor includes a rotor, a stator, and a motor housing. The pump includes a pump rotor and a pump housing. The motor housing includes a bottomed tubular shape including a bottom portion on the inverter side, and the inverter portion includes an inverter housing that accommodates a circuit board. The inverter includes a metal base plate on a front side of the inverter housing and extends in the radial direction with respect to the central axis. The base plate is fixed to the bottom portion of the motor housing.

### CROSS REFERENCE TO RELATED APPLICATIONS

This is a U.S. national stage of PCT Application No. PCT/JP2018/030398, filed on Aug. 16, 2018, and priority under 35 U.S.C. § 119(a) and 35 U.S.C. § 365(b) is claimed from Japanese Application No. 2017-167828, filed Aug. 31, 2017, the entire disclosures of each application being hereby incorporated herein by reference.

### 1. FIELD OF THE INVENTION

The present disclosure relates to an electric oil pump.

### 2. BACKGROUND

For example, Japanese Unexamined Patent Application Publication No. 2013-092126 discloses an electric oil pump in which an inverter having a circuit board and an electric pump are integrated. The electric oil pump has an oil pump unit and an inverter unit. The oil pump unit of the electric oil pump is inserted into a pump accommodation hole provided in a housing of a transmission, the inverter unit is disposed along an outer surface of the housing on the motor unit side of the oil pump unit, and the oil pump unit and the inverter unit are fixed to the housing of the transmission via bolts.

The electric oil pump described in Japanese Patent Application, First Publication No. 2013-092126 is fixed in the transmission, but the electric oil pump may be fixed outside the transmission. When the electric oil pump is fixed outside the transmission, the inverter unit is cantilever-supported at a fixing position of the electric oil pump to the transmission. Therefore, when vibration generated by an engine or the like is propagated to the electric oil pump via the transmission, the inverter unit at a position away from the fixing position may vibrate more greatly than that of the vibration propagated to the electric oil pump. Therefore, a rib of an electronic component (for example, a capacitor) mounted on the circuit board may become disconnected.

### SUMMARY

Example embodiments of the present disclosure provide electric oil pumps in each of which a likelihood that electronic components mounted on a circuit board in an inverter will be damaged by vibration is reduced or prevented when an electric oil pump including an inverter is fixed.

An example embodiment of the present disclosure is an electric oil pump including a motor including a shaft centered on a central axis extending in an axial direction, a pump on one side of the motor in an axial direction, driven by the motor via the shaft and discharges oil, and an inverter on the other side of the motor in the axial direction and fixed to the motor, wherein the motor includes a rotor fixed to the other side of the shaft in the axial direction, a stator positioned outward from the rotor in a radial direction, and a motor housing that accommodates the rotor and the stator, the pump includes a pump rotor mounted on the shaft protruding from the motor to one side in the axial direction, and a pump housing including an accommodation portion that accommodates the pump rotor, the motor housing has a bottomed tubular shape including a bottom portion on an inverter side, the inverter includes an inverter housing including a circuit board accommodation portion that accommodates a circuit board, the inverter includes a metal base plate on one side of the inverter housing in the axial direction and extends in a radial direction with respect to the central axis, and the base plate is fixed to the bottom portion of the motor housing of the motor.

According to the example embodiment of the present disclosure, it is possible to provide an electric oil pump that decreases or prevents a likelihood that terminals of electronic components mounted on a circuit board in an inverter are damaged when the electric oil pump including the inverter is fixed.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of an electric oil pump according to a first example embodiment of the present disclosure.

FIG. 2 is a bottom view of a base plate according to the first example embodiment of the present disclosure when seen from the front side.

FIG. 3 is a cross-sectional view of an L-shaped base plate according to a second example embodiment of the present disclosure.

FIG. 4 is a cross-sectional view of a modified example of the L-shaped base plate according to the second example embodiment of the present disclosure.

FIG. 5 is a cross-sectional view of an inverter housing having a base plate according to a third example embodiment of the present disclosure.

FIG. 6 is a cross-sectional perspective view of the inverter housing fixed with a plurality of bolts according to a third example embodiment of the present disclosure when seen obliquely from the front side.

### DETAILED DESCRIPTION

Hereinafter, electric oil pumps according to example embodiments of the present disclosure will be described with reference to the drawings. Moreover, in the following drawings, the scale and the numbers in an actual structure may be different from those in respective structures to make each of the structures easy to understand.

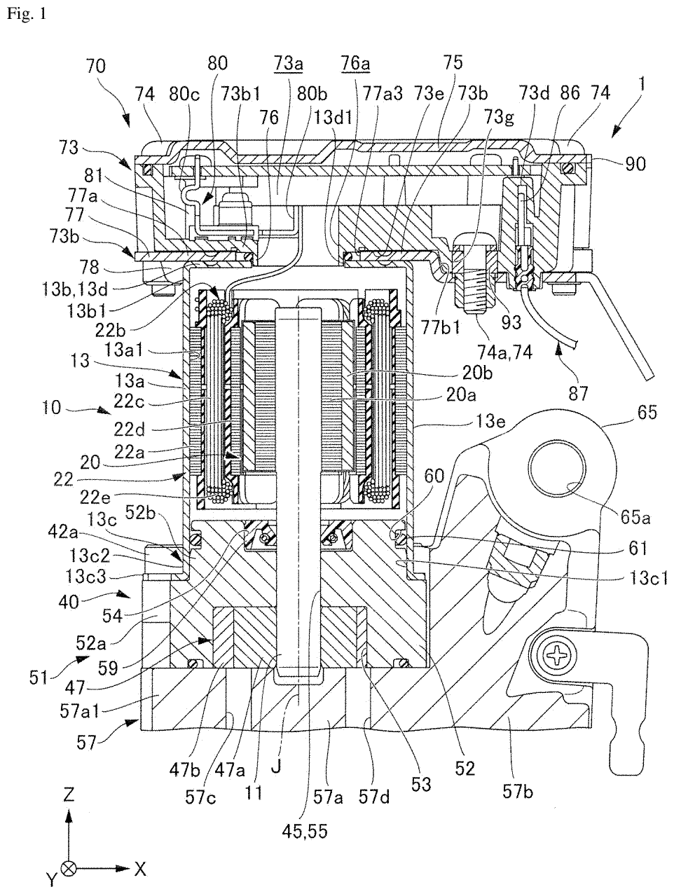

Further, in the drawings, an XYZ coordinate system is appropriately shown as a three-dimensional orthogonal coordinate system. In the XYZ coordinate system, a Z-axis direction is a direction parallel to the other axial direction of a central axis J shown in FIG. 1. An X-axis direction is a direction parallel to a transverse direction of the electric oil pump shown in FIG. 1, that is, a right and left direction in FIG. 1. A Y-axis direction is a direction orthogonal to both the X-axis direction and the Z-axis direction.

Further, in the following description, the positive side (the positive Z side) in the Z-axis direction is referred to as “rear side,” and the negative side (the negative Z side) in the Z-axis direction is referred to as “front side.” The rear side and the front side are simply names used for explanation and do not limit an actual positional relationship or direction. Furthermore, unless otherwise specified, a direction (the Z-axis direction) parallel to the central axis J is simply referred to as “axial direction,” a radial direction centered on the central axis J is simply referred to as “radial direction,” and a circumferential direction around the central axis J, that is, around a circumference (in a C direction) around the central axis J is simply referred to as “circumferential direction.”

In this specification, “extending in the axial direction” includes not only a case of extending strictly in the axial direction (the Z-axis direction) but also a case of extending in a direction inclined in a range of less than 45° with respect to the axial direction. Moreover, in this specification, “extending in the radial direction” includes not only a case of extending strictly in the radial direction, that is, in a direction perpendicular to the axial direction (the Z-axis direction) but also a case of extending in a direction inclined in a range of less than 45° with respect to the radial direction.

### First Example Embodiment

### <Overall Configuration>

FIG. 1 is a cross-sectional view of an electric oil pump according to a first example embodiment. The electric oil pump 1 of the example embodiment includes a motor unit 10, a pump unit 40, and an inverter unit 70, as shown in FIG. 1. The motor unit 10 and the pump unit 40 are disposed in the axial direction. The motor unit 10 includes a shaft 11 disposed along the central axis J which extends in the axial direction. The pump unit 40 is positioned on one side (the front side) of the motor unit 10 in the axial direction, and is driven by the motor unit 10 via the shaft 11 and discharges oil. The inverter unit 70 is positioned on the other side (the rear side) of the motor unit 10 in the axial direction and is fixed to the motor unit 10 via a base plate 77. Hereinafter, respective constituent members will be described in detail.

### <Motor Unit 10>

As shown in FIG. 1, the motor unit 10 includes a motor housing 13, a rotor 20, the shaft 11, and a stator 22.

The motor unit 10 is, for example, an inner rotor type motor. The rotor 20 is fixed to an outer peripheral surface of the shaft 11, and the stator 22 is positioned on the outward side of the rotor 20 in the radial direction.

### (Motor Housing 13)

The motor housing 13 includes a stator holding portion 13a, an inverter holding portion 13b, and a pump body holding portion 13c. The motor housing 13 is made of a metal. The motor housing 13 has a bottomed tubular shape having a bottom portion 13d on the inverter unit 70 side.

### (Stator Holding Portion 13a)

The stator holding portion 13a extends in the axial direction and has a through hole 13al therein. The shaft 11, the rotor 20, and the stator 22 of the motor unit 10 are disposed in the through hole 13al. An outer surface of the stator 22, that is, an outer surface of a core back portion 22a which will be described later is fitted to an inner surface of the stator holding portion 13a. Thus, the stator 22 is accommodated in the stator holding portion 13a.

### (Inverter Holding Portion 13b)

The inverter holding portion 13b is a portion connected to a rear side end portion 13b1 of the stator holding portion 13a. In the example embodiment, the inverter holding portion 13b includes the rear side end portion 13b1 of the stator holding portion 13a, and the disk-like bottom portion 13d which extends inward from the rear side end portion 13b1 in the radial direction. A motor unit side through hole 13d1 which penetrates therethrough in the axial direction is provided in a center portion of the bottom portion 13d. A coil end insertion portion 76 provided to protrude from a front side bottom portion of the inverter unit 70 is inserted into the motor unit side through hole 13d1. An inverter unit side through hole 76a which penetrates therethrough in the axial direction is provided in the coil end insertion portion 76. The inverter unit side through hole 76a allows the motor unit 10 and the inverter unit 70 to communicate with each other. Details of the coil end insertion portion 76 will be described later.

The base plate 77 provided at a front side end portion of the inverter unit 70 is placed on the bottom portion 13d of the motor housing 13, and the base plate 77 is welded to the bottom portion 13d. Thus, the inverter unit 70 is fixed to the bottom portion 13d of the motor housing 13.

### (Pump Body Holding Portion 13c)

The pump body holding portion 13c has a tubular shape of which the front side opens and is continuously connected to a front side end of the stator holding portion 13a. The pump body holding portion 13c has a hole portion 13c1 which extends in the axial direction. An inner diameter of the hole portion 13c1 has a dimension which is slightly larger than a rear side outer diameter of the pump body 52 of the pump unit 40 which will be described later. The rear side of the pump body 52 is fitted to an inner surface of the hole portion 13c1.

An outer surface 13c2 of the pump body holding portion 13c has a motor side flange portion 13c3 which protrudes in the radial direction. The motor side flange portion 13c3 is disposed to face a pump side flange portion 52a provided on the pump body 52 which will be described later and is fixed to the pump side flange portion 52a by a fixing member such as a bolt 42a. Thus, the pump unit 40 is fixed to the motor housing 13.

### (Rotor 20)

The rotor 20 has a rotor core 20a and a rotor magnet 20b. The rotor core 20a surrounds a circumference (in the 0 direction) of the shaft 11 around the axis and is fixed to the shaft 11. The rotor magnet 20b is fixed to an outer surface of the rotor core 20a along a circumference (in the 0 direction) around the axis. The rotor core 20a and the rotor magnet 20b rotate together with the shaft 11. The rotor 20 may be an embedded magnet type in which a permanent magnet is embedded in the rotor 20. The embedded magnet type rotor 20 can reduce a likelihood of the magnet coming off due to a centrifugal force and also can actively use a reluctance torque, in contrast to a surface magnet type in which the permanent magnet is provided on the surface of the rotor 20.

### (Stator 22)

The stator 22 surrounds a circumference (in the 0 direction) of the rotor 20 around the axis and rotates the rotor 20 around the central axis J. The stator 22 includes the core back portion 22a, a tooth portion 22c, a coil 22b, and an insulator (a bobbin) 22d.

A shape of the core back portion 22a is a cylindrical shape which is concentric with the shaft 11. The tooth portion 22c extends from an inner surface of the core back portion 22a toward the shaft 11. A plurality of tooth portions 22c are provided and are disposed at regular intervals in the circumferential direction of the inner surface of the core back portion 22a. The coil 22b is provided around the insulator (the bobbin) 22d, and is formed by winding a conducting wire 22e. The insulator (the bobbin) 22d is mounted on each of the tooth portions 22c.

### (Shaft 11)

As shown in FIG. 1, the shaft 11 extends along the central axis J and passes through the motor unit 10. The front side (the negative Z side) of the shaft 11 protrudes from the motor unit 10 and extends into the pump unit 40. The rear side (the positive Z side) of the shaft 11 protrudes from the rotor 20 and becomes a free end. Thus, the rotor 20 is in a cantilever-supported state in which the front side of the shaft 11 is supported by a slide bearing 45 which will be described later.

### (Inverter Unit 70)

The inverter unit 70 includes a bottomed container-shaped inverter housing 73 that has a circuit board accommodation portion 73a of which the rear side opens and is recessed on the front side and that extends in the X-axis direction, and a cover 90.

In the circuit board accommodation portion 73a, the rear side opening of the circuit board accommodation portion 73a is covered by the cover 90. A circuit board 75, a circuit board connection portion 80c, a bus bar 80, a terminal portion 86, and the like are accommodated in the circuit board accommodation portion 73a.

The circuit board connection portion 80c is disposed on the left side in the X-axis direction in the circuit board accommodation portion 73a, and one end side thereof is electrically connected to a coil end 22b1 of the motor unit 10 via the bus bar 80, and the other end side thereof is electrically connected to the circuit board 75. The terminal portion 86 is a terminal which is disposed on the right side in the X-axis direction in the circuit board accommodation portion 73a and provided at one end portion of an external cable 87. The terminal portion 86 is mounted in the circuit board accommodation portion 73a and is electrically connected to the circuit board 75.

The circuit board 75 outputs a motor output signal. The circuit board 75 is disposed on the rear side of the circuit board accommodation portion 73a and extends in a direction intersecting the axial direction. In the example embodiment, the circuit board 75 extends in the X-axis direction orthogonal to the axial direction. A printed wiring which is not shown is provided on a side surface (a front side surface 75a) of the circuit board 75 on the front side. Further, a plurality of electronic components are mounted on the front side surface 75a of the circuit board 75. Heat generated due to a heating element which is not shown can be radiated through the cover portion using a copper inlay substrate as the circuit board 75.

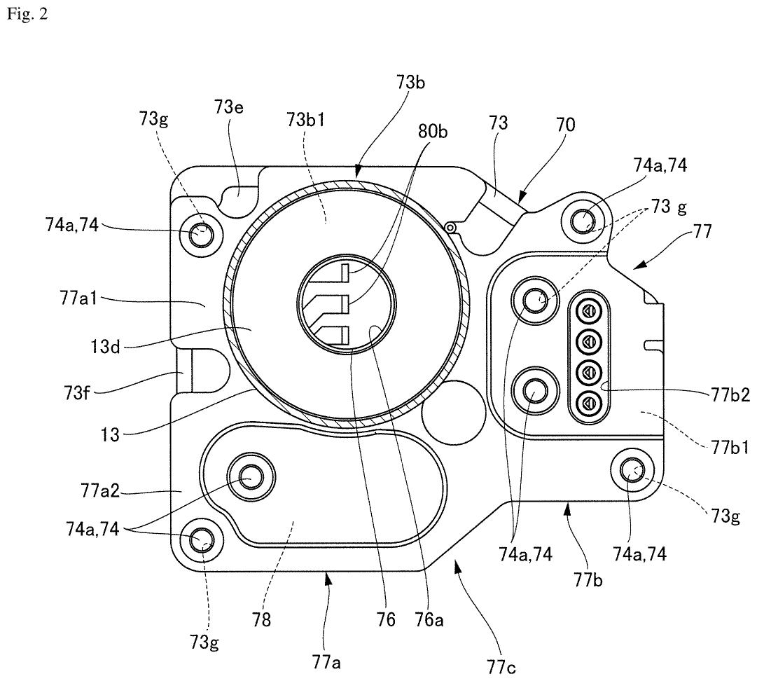

FIG. 2 is a bottom view of the base plate 77 according to the example embodiment when seen from the front side. As shown in FIGS. 1 and 2, the front side of the inverter housing 73 has an inverter housing fixing portion 73b which is fixed to the bottom portion 13d of the motor housing 13 via the base plate 77. The inverter housing fixing portion 73b has a plate-shaped fixing surface portion 73b1 which extends along the bottom portion 13d. In the example embodiment, the inverter housing fixing portion 73b has a disk shape when seen in the axial direction. A bus bar holder 81 having the bus bar 80 is fastened on the fixing surface portion 73b1.

The inverter housing 73 has the base plate 77 on the front side. The base plate 77 is made of a metal and extends along a bottom surface 73e of the inverter housing 73 on the front side. The base plate 77 has a similar shape larger than that of the bottom surface 73e of the inverter housing 73 on the front side and covers the bottom surface 73e. The base plate 77 includes a first base plate 77a having the fixing surface portion 73b1, and a second base plate 77b which extends from an end portion of the first base plate 77a on the positive side in the X-axis direction to the positive side in the X-axis direction.

The first base plate 77a includes a fixing main body portion 77al fixed to the bottom portion 13d of the motor housing 13, and an extension portion 77a2 which extends from an end portion of the fixed main body portion 77al on the positive side in the Y-axis direction to the positive side in the Y-axis direction. A central portion of the fixing main body portion 77al has a hole portion 77a3 which communicates with the motor unit side through hole 13d1 which opens to the bottom portion 13d of the motor housing 13. The fixing main body portion 77al is placed on the planar bottom portion 13d of the motor housing 13 with the hole portion 77a3 communicating with the motor unit side through hole 13d1 and is fixed to the bottom portion 13d by welding (for example, spot welding).

An electronic component arrangement recessed portion 78 which opens on the rear side and is recessed to the front side is provided in the extension portion 77a2. The electronic component arrangement recessed portion 78 is positioned on the outward side of the motor housing 13 in the radial direction. The electronic component arrangement recessed portion 78 has an oval shape which has a predetermined width in the Y-axis direction and extends in the X-axis direction. The predetermined width of the electronic component arrangement recessed portion 78 is large enough to allow insertion of a relatively large capacitor and choke coil.

The second base plate 77b has an external terminal mounting recessed portion 77b1 which is recessed from the rear side to the front side. The external terminal mounting recessed portion 77b1 opens on the rear side and the positive side in the X axis direction. A hole portion 77b2 which extends in the Y-axis direction is provided in a central portion of the external terminal mounting recessed portion 77b1. The hole portion 77b2 exposes a front side end portion of an external terminal receiving portion 73d provided in the inverter housing 73. The external terminal receiving portion 73d is provided in the inverter housing 73 on the rear side with respect to the external terminal mounting recessed portion 77b1. The base plate 77 has a plate shape, but a rigidity thereof is enhanced by having the electronic component arrangement recessed portion 78 and the external terminal mounting recessed portion 77b1. In the base plate 77, a portion of the base plate 77 which is positioned on the outward side of the motor housing 13 in the radial direction is referred to as a base plate extension portion 77c.

The inverter housing 73 is fixed to the base plate 77 via a fixing member 74 such as a bolt 74a. In the shown example embodiment, in a state in which the first base plate 77a of the base plate 77 is in contact with the bottom surface 73e of the inverter housing 73 on the front side, the electronic component arrangement recessed portion 78 and the front side bottom surface 73e of the inverter housing 73, and the external terminal mounting recessed portion 77b1 and the front side bottom surface 73e of the inverter housing 73 are fastened and fixed via the fixing member 74. A fixing member through hole 73g which penetrates therethrough in the axial direction to allow the fixing member 74 to pass therethrough is provided in the inverter housing 73. Further, the inverter housing 73 is fixed to the base plate 77 via the fixing members 74 passed through four corner portions of the cover 90 and the inverter housing 73. In the inverter housing 73, a portion of the inverter housing 73 which is positioned on the outward side of the motor housing 13 in the radial direction is referred to as an inverter housing extension portion 73f. That is, the base plate extension portion 77c and the inverter housing extension portion 73f are fixed by the fixing member 74.

However, since the inverter housing 73 is made of a resin, when the fixing member 74 directly fastens the inverter housing 73, the inverter housing 73 may be damaged. Thus, the fixing member 74 passes through a collar 93 made of a metal and fixes the inverter housing 73 to the base plate 77 via the collar 93.

The bus bar holder 81 having a plurality of bus bars 80 is disposed on the fixing surface portion 73b1 of the inverter housing fixing portion 73b. The bus bar holder 81 is disposed on the side opposite to the terminal portion 86 side with respect to the central axis J. In the example embodiment, the bus bar holder 81 is disposed on the left side in the X-axis direction with respect to the inverter unit side through hole 76a.

The bus bar 80 includes a coil end connection portion 80b and the circuit board connection portion 80c. The coil end connection portion 80b extends from a bottom portion of the bus bar holder 81 on the inverter unit side through hole 76a side toward the inverter unit side through hole 76a on the side to the rear in the axial direction of an opening portion of the inverter unit side through hole 76a and is connected to the coil end 22b1 which extends from the motor unit 10. The circuit board connection portion 80c extends from the bottom portion of the bus bar holder 81 on the side opposite to the terminal portion 86 side with respect to the central axis J toward the rear side and is connected to the circuit board 75. In the example embodiment, three bus bars 80 are provided in the bus bar holder 81 and are disposed with intervals therebetween in the Y-axis direction. The bus bar 80 and the bus bar holder 81 are integrally molded products made of a resin.

### <Pump Unit 40>

As shown in FIG. 1, the pump unit 40 is positioned on one side of the motor unit 10 in the axial direction, specifically, on the front side (the negative Z side). The pump unit 40 is driven through the shaft 11 by the motor unit 10. The pump unit 40 includes a pump rotor 47 and a pump housing 51. The pump housing 51 includes a pump body 52 and a pump cover 57. Hereinafter, respective components will be described in detail.

### (Pump Body 52)

The pump body 52 is fixed to the front side (the negative Z side) of the motor housing 13 on the front side (the negative Z side) of the motor unit 10. The pump body 52 has a recessed portion 54 which is recessed from a surface on the rear side (the positive Z side) to the front side (the negative Z side). A seal member 59 is accommodated in the recessed portion 54. The pump body 52 includes an accommodation portion 53 which accommodates the pump rotor 47 and has a side surface and a bottom surface positioned on the rear side (the positive Z side) of the pump unit 40. The accommodation portion 53 opens to the front side (the negative Z side) and is recessed to the rear side (the positive Z side). A shape of the accommodation portion 53 seen in the axial direction is a circular shape.

The pump cover 57 covers the pump body 52 from the front side (the negative Z side), and thus the accommodation portion 53 is provided between the pump cover 57 and the pump body 52. A toric recessed portion 60 which is recessed inward in the radial direction is provided on an outer surface 52b of the pump body 52 on the rear side. A seal member 61 (for example, an O-ring) is inserted into the recessed portion 60.

The pump body 52 has a through hole 55 which passes therethrough along the central axis J. The through hole 55 opens on both ends in the axial direction to allow the shaft 11 to pass therethrough, an opening on the rear side (the positive Z side) opens into the recessed portion 54, and an opening on the front side (the negative Z side) opens into the accommodation portion 53. The through hole 55 serves as a slide bearing 45 which supports the shaft 11 rotatably.

A pump side flange portion 52a is provided at an outer end portion of the pump body 52 in the radial direction. A plurality of the pump side flange portions 52a are provided at intervals in the circumferential direction.

### (Pump Cover 57)

As shown in FIG. 1, the pump cover 57 includes a pump cover main body portion 57a which is mounted on the front side of the pump body 52, and a pump cover arm portion 57b which extends from an end portion of the pump cover main body portion 57a on one side in the radial direction toward the motor unit 10.

A pump cover side flange portion 57a1 is provided at an outer end portion of the pump cover main body portion 57a in the radial direction. The plurality of pump cover side flange portions 57a1 are provided at intervals in the circumferential direction. A female screw to which the bolt 42a can be screwed is provided in each of the pump cover side flange portions 57al.

The motor side flange portion 13c3 and the pump side flange portion 52a are disposed on the pump cover side flange portion 57a1 to overlap each other, the bolt 42a passed through the motor side flange portion 13c3 and the pump side flange portion 52a is fastened to a female screw provided in the pump cover side flange portion 57al, and thus the motor unit 10 can be fixed to the pump unit 40.

The pump cover arm portion 57b extends from the outer end portion of the pump cover main body portion 57a on one side in the radial direction to the rear side of the motor unit 10 along an outer surface 13e of the motor housing 13. The pump cover arm portion 57b is formed in a rectangular parallelepiped shape, and a rigidity thereof is enhanced. A pump fixing portion 65 to be fixed is provided at an end portion of the pump cover arm portion 57b on the rear side. In the example embodiment, the pump fixing portion 65 is fixed to a transmission, for example. The pump fixing portion 65 has a box shape and has a fixing hole portion 65a which penetrates therethrough in the Y-axis direction. A fixing member such as a bolt is inserted into the fixing hole portion 65a, and the pump fixing portion 65 is firmly fixed to a fixing target object such as a transmission.

In the example embodiment, an example in which the accommodation portion 53 which accommodates the pump rotor 47 is provided in the pump body 52 has been shown, but the present disclosure is not limited thereto. The accommodation portion 53 may be provided in the pump cover 57.

### (Pump Rotor 47)

The pump rotor 47 is mounted on the shaft 11. More specifically, the pump rotor 47 is mounted on the front side (the negative Z side) of the shaft 11. The pump rotor 47 includes an inner rotor 47a mounted on the shaft 11, and an outer rotor 47b surrounding the outward side of the inner rotor 47a in the radial direction. The inner rotor 47a has a toric shape. The inner rotor 47a is a gear having teeth on an outer surface in the radial direction.

The inner rotor 47a is fixed to the shaft 11. More specifically, an end portion of the shaft 11 on the front side (the negative Z side) is press-fitted into the inner rotor 47a. The inner rotor 47a rotates around (in the C direction) the shaft together with the shaft 11. The outer rotor 47b has a toric shape which surrounds the outward side of the inner rotor 47a in the radial direction. The outer rotor 47b is a gear having teeth on an inner surface in the radial direction.

The inner rotor 47a and the outer rotor 47b mesh with each other, and the outer rotor 47b rotates when the inner rotor 47a rotates. That is, the pump rotor 47 is rotated by rotation of the shaft 11. In other words, the motor unit 10 and the pump unit 40 have the same rotation axis. Accordingly, it is possible to curb an increase in size of the electric oil pump 1 in the axial direction.

In addition, when the inner rotor 47a and the outer rotor 47b rotate, the volume between meshing parts of the inner rotor 47a and the outer rotor 47b changes. A region in which the volume decreases becomes a positive pressure region, and a region in which the volume increases becomes a negative pressure region. A suction port is disposed on the rear side (the positive Z side) of the negative pressure region of the pump rotor 47. Further, a discharge port is disposed on the rear side (the positive Z side) of the positive pressure region of the pump rotor 47. Here, oil suctioned into the accommodation portion 53 from an inlet port 57c provided in the pump cover 57 is accommodated in a volume portion between the inner rotor 47a and the outer rotor 47b and sent to the positive pressure region. Thereafter, the oil passes through the discharge port and is discharged from an outlet port 57d provided in the pump cover 57.

### <Operation and Effect of Electric Oil Pump 1>

Next, an operation and effect of the electric oil pump 1 will be described. As shown in FIG. 1, when the motor unit 10 of the electric oil pump 1 is driven, the shaft 11 of the motor unit 10 rotates, and the outer rotor 47b also rotates in accordance with the rotation of the inner rotor 47a of the pump rotor 47. When the pump rotor 47 rotates, the oil suctioned from the inlet port 57c of the pump unit 40 moves through the accommodation portion 53 of the pump unit 40, passes through the discharge port and is discharged from the outlet port 57d.

(1) Here, the inverter unit 70 of the electric oil pump 1 according to the example embodiment includes the metal base plate 77 which is disposed on one side of the inverter housing 73 in the axial direction and extends in the radial direction, and the base plate 77 is fixed to the bottom portion 13d of the motor housing 13 of the motor unit 10. Thus, the inverter unit 70 can be firmly fixed to the motor unit 10 via the base plate 77. Moreover, since the inverter unit 70 has the metal base plate 77 which extends in the radial direction with respect to the central axis J, the rigidity of the inverter unit 70 can be increased.

(2) Further, since the base plate 77 has a plate shape and extends in a direction along an end surface (a front side bottom surface 73e) of the inverter housing 73 on one side in the axial direction to cover the end surface, the entire end surface of the inverter unit 70 is supported by the base plate 77. Thus, the rigidity of the inverter housing 73 can be further increased. In addition, since the base plate 77 is welded to the bottom portion 13d of the motor housing 13, the base plate 77 and the motor housing 13 can be fixed integrally and firmly.

(3) Further, the fixing member 74 fixes the inverter housing extension portion 73f to the base plate extension portion 77c via the metal collar 93. Rigidity of a resin is lower than that of a metal. Therefore, if the fixing member 74 is in pressure contact with the inverter housing extension portion 73f made of a resin when the inverter housing extension portion 73f is fixed to the base plate extension portion 77c by the fixing member 74, the inverter housing extension portion 73f may be damaged. Thus, a pressure contact force of the fixing member 74 can be transmitted to the base plate extension portion 77c via the collar 93 by fixing the inverter housing extension portion 73f to the base plate extension portion 77c via the collar 93. Accordingly, there is no possibility that an excessive pressure contact force may act on the inverter housing extension portion 73f made of a resin, and damage to the inverter housing extension portion 73f can be prevented.

(4) In addition, since a length of the collar 93 in the axial direction is larger than a thickness of the fixing member through hole 73g in the axial direction, most of the pressure contact force of the fixing member 74 can be transmitted to the collar 93 when the inverter housing 73 is fixed to the motor housing 13 by the fixing member 74. Accordingly, the possibility that the inverter housing 73 made of a resin may be damaged can be further reduced.

### Second Example Embodiment

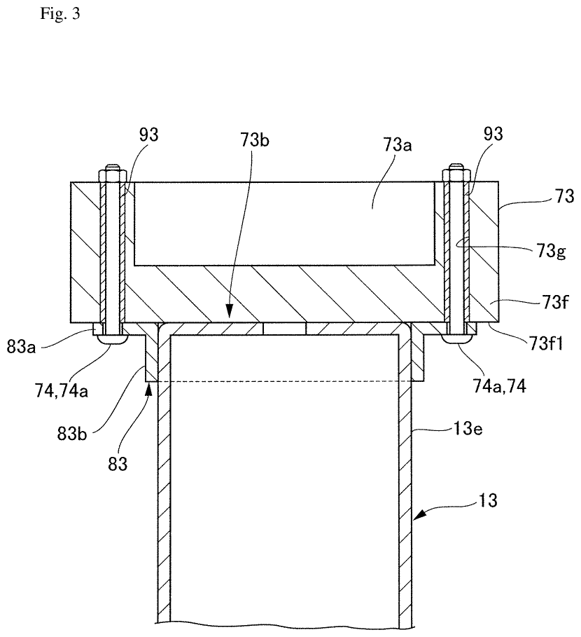

FIG. 3 is a cross-sectional view of an L-shaped base plate 83 according to a second example embodiment. In the second example embodiment, only differences from the first example embodiment described above will be described, the same aspects as those in the first example embodiment will be designated by the same reference numerals, and description thereof will be omitted.

As shown in FIG. 3, the inverter housing fixing portion 73b has an L-shaped base plate 83. The base plate 83 has an L shape which extends inward from the outward side of an end surface 73f1 in the radial direction along the end surface 73f1 of the inverter housing extension portion 73f on one side in the axial direction which extends to the outward side of the motor housing 13 of the inverter housing 73 in the radial direction, and is bent to one side in the axial direction along the outer surface 13e of the motor housing 13 on the other side in the axial direction.

The base plate 83 has a base plate extension portion 83a which extends along the inverter housing extension portion 73f, and a base plate body portion 83b. The base plate extension portion 83a extends along the end surface 73f1 of inverter housing extension portion 73f. The base plate body portion 83b extends along the outer surface 13e of the motor housing 13. In the example embodiment, the base plate body portion 83b has a tubular shape which surrounds the outer surface 13e of the motor housing 13. Furthermore, the base plate extension portion 83a has a toric shape when seen in the axial direction.

The base plate extension portion 83a of the base plate 83 is fixed to the inverter housing extension portion 73f via the fixing member 74. In the example embodiment, a fixing member through hole 73g which penetrates therethrough in the axial direction is provided in the inverter housing extension portion 73f, the metal collar 93 is inserted into the fixing member through hole 73g, and the inverter housing extension portion 73f is fastened and fixed to the base plate 83 via the base plate extension portion 83a and the fixing member 74 inserted into the fixing member through hole 73g. On the other hand, the base plate body portion 83b of the base plate 83 is fixed to the outer surface 13e of the motor housing 13 by press-fitting or welding.

### <Operation and Effect of Electric Oil Pump 1 According to Second Example Embodiment>

(1) Here, since the base plate body portion 83b according to the second example embodiment is fixed along a shape of the outer surface 13e of the motor housing 13, the base plate body portion 83b can be firmly fixed to the motor housing 13. Accordingly, the inverter housing 73 fixed via the base plate extension portion 83a can be firmly fixed to the motor housing 13 via the L-shaped base plate 83. In addition, since the inverter housing 73 and the base plate 83 are integrally molded with a resin, the rigidity of the inverter housing 73 molded with a resin can be increased.

### Modified Example of Second Example Embodiment

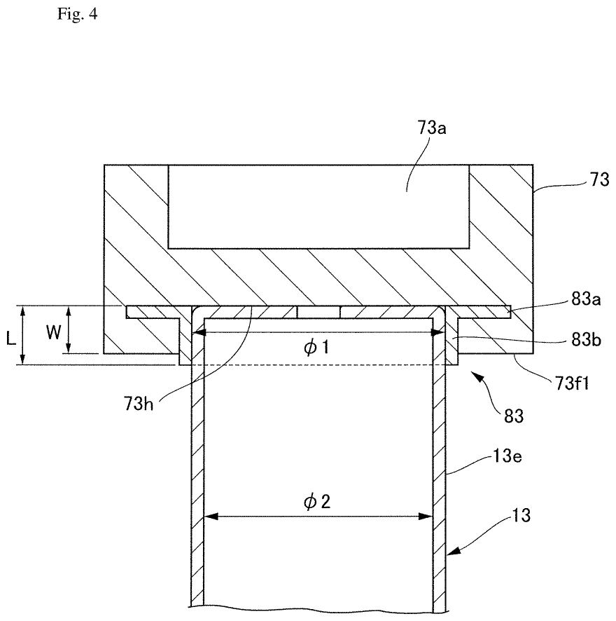

FIG. 4 is a cross-sectional view of a modified example of the L-shaped base plate 83 according to the second example embodiment. As shown in FIG. 4, the inverter housing 73 and the base plate 83 are integrally formed of a resin. In the example embodiment, the L-shaped base plate 83 is disposed on the front side of the circuit board accommodation portion 73a of the inverter housing 73, and an end portion of the base plate body portion 83b on the front side protrudes from the end surface 73f1 of the inverter housing 73 on the front side (first modified example).

Further, an insertion hole portion 73h into which the front side of the motor housing 13 can be inserted is provided on the front side of the inverter housing 73. The insertion hole portion 73h has a circular shape when seen from the front side. An inner diameter φ1 of the insertion hole portion 73h is slightly larger than an outer diameter φ2 of the motor housing 13. Furthermore, a depth W of the insertion hole portion 73h in the axial direction is smaller than a length L of the base plate body portion 83b in the longitudinal direction. The base plate body portion 83b is fixed to the outer surface 13e by press-fitting or welding.

In the modified example, since the inverter housing 73 and the base plate 83 are integrally formed of a resin, the rigidity of the inverter housing 73 can be increased. Moreover, a component which fixes the base plate 83 to the inverter housing 73 becomes unnecessary, and thus the number of components can be reduced.

### Third Example Embodiment

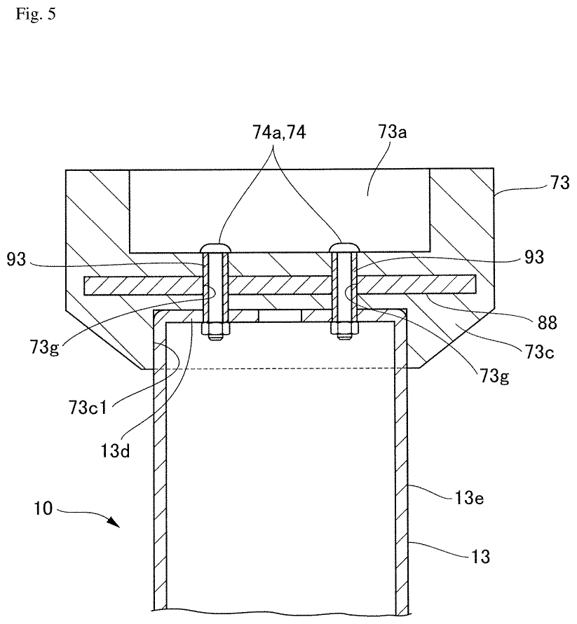

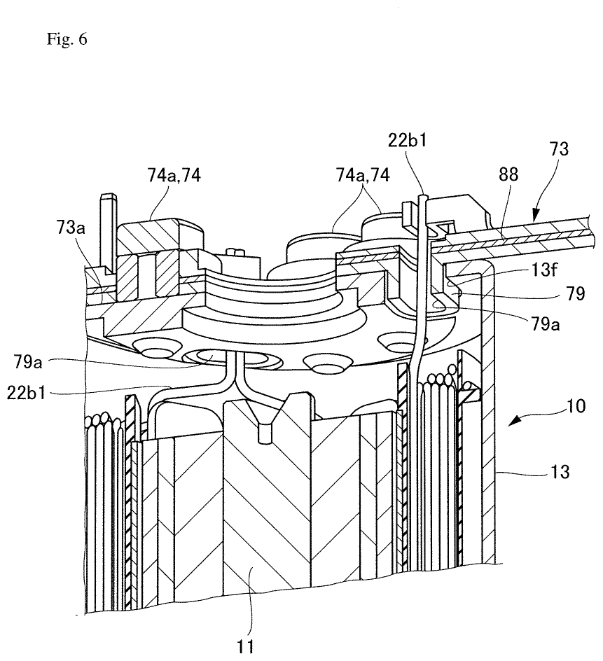

FIG. 5 is a cross-sectional view of an inverter housing 73 having a base plate 88 according to a third example embodiment. FIG. 6 is a cross-sectional perspective view of the inverter housing 73 fixed by a plurality of bolts 74a according to the third example embodiment when seen from the oblique front side.

In the second example embodiment, the case in which the L-shaped base plate 83 and the inverter housing 73 are integrally molded has been described. However, the flat base plate 88 and the inverter housing 73 may be integrally molded. In the example embodiment, as shown in FIG. 5, the flat base plate 88 is disposed in the inverter housing 73 on the front side of the circuit board accommodation portion 73a. In the example embodiment, the inverter housing 73 and the motor housing 13 are fastened and fixed by the fixing member 74 which has passed through the fixing member through hole 73g that passes through a bottom surface of the circuit board accommodation portion 73a in the axial direction. The fixing member through hole 73g also passes through the base plate 88. The collar 93 made of a metal is inserted into the fixing member through hole 73g.

Further, a wall portion 73c which protrudes to the motor unit 10 side is provided on the front side of the inverter housing 73. A fitting hole portion 73c1 into which the rear side of the motor housing 13 can be inserted is provided inside the wall portion 73c. Therefore, the inverter housing 73 is fixed to the motor housing 13 in a state in which it is inserted into the fitting hole 73c1.

In the modified example, since the inverter housing 73 and the base plate 88 are integrally molded with a resin, the rigidity of the inverter housing 73 molded with a resin can be increased. Further, a means for fixing the base plate 88 to the inverter housing 73 becomes unnecessary, and the number of components can be reduced. Furthermore, since the base plate 88 is fixed to the bottom portion 13d of the motor housing 13 via the fixing member 74, the inverter housing 73 can be firmly fixed to the motor housing 13 via the base plate 88.

### Modified Example of Third Example Embodiment

FIG. 6 is a cross-sectional perspective view of the inverter housing 73 fixed by the plurality of bolts 74a according to the third example embodiment when seen from the oblique front side. In the above-described example embodiment, although the coil end 22b1 which extends from the motor unit 10 passes through the inverter unit side through hole 76a including the central axis J, a protruding portion 79 for passing the coil end 22b1 may be provided on the inverter housing fixing portion 73b on the outward side in the radial direction with respect to the central axis J.

In the example embodiment, as shown in FIG. 6, the protruding portion 79 is provided on the fixing surface portion 73b1 of the inverter housing 73 and protrudes to the motor unit 10 side. The protruding portion 79 has a coil end through hole 79a which penetrates therethrough in the axial direction. The motor housing 13 has an insertion hole 13f, into which the protruding portion 79 is inserted, in the bottom portion 13d. In a state in which the protruding portion 79 is inserted into the insertion hole 13f, an end portion of the protruding portion 79 on the one side in the axial direction protrudes from an opening portion of the insertion hole 13f on one side in the axial direction. The coil end 22b1 which extends from the motor unit 10 passes through the coil end through hole 79a and extends into the inverter unit 70.

In the modified example, since the end portion of the protruding portion 79 on one side in the axial direction protrudes from the opening portion of the insertion hole 13f on the one side in the axial direction in the state in which the protruding portion 79 is inserted into the insertion hole 13f, the coil end 22b1 is protected by the protruding portion 79 in a state in which the coil end 22b1 has passed through the protruding portion 79. Therefore, the possibility that the coil end 22b1 may come into contact with the bottom portion 13d of the motor housing 13 made of a metal is prevented, and insulation of the coil end 22b1 can be maintained.

Further, as shown in FIG. 6, the fixing members 74 and the coil end through holes 79a may be alternately disposed in the inverter housing fixing portion 73b of the inverter housing 73 in the circumferential direction with respect to the central axis J. Since the fixing member 74 and the coil end through hole 79a are alternately disposed in the inverter housing fixing portion 73b, the fixing member 74 which fixes the inverter housing 73 to the motor housing 13 and the coil end through hole 79a which does not contribute to the fixing can be disposed adjacent to each other. Accordingly, it is possible to prevent the possibility that a region in which the inverter housing 73 and the motor housing 13 are not fixed is enlarged.

As described above, although the preferable example embodiments of the present disclosure have been described, the present disclosure is not limited to these example embodiments, and various modifications and changes are possible within the range of the summary. The example embodiments and the modifications thereof are included in the scope and gist of the disclosure, and at the same time, are included in the disclosure described in the claims and the equivalents thereof.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-11. (canceled)

12: An electric oil pump comprising:
a motor including a shaft centered on a central axis extending in an axial direction;
a pump on one side of the motor in an axial direction and driven by the motor via the shaft to discharge oil; and
an inverter on the other side of the motor in the axial direction and fixed to the motor; wherein
the motor includes a rotor fixed to the other side of the shaft in the axial direction, a stator positioned outward from the rotor in a radial direction, and a motor housing to accommodate the rotor and the stator;
the pump includes a pump rotor mounted on the shaft that protrudes from the motor to one side in the axial direction, and a pump housing including an accommodation portion to accommodate the pump rotor;
the motor housing includes a bottomed tubular shape including a bottom portion on an inverter side;
the inverter includes an inverter housing including a circuit board accommodation portion to accommodate a circuit board;
the inverter includes a metal base plate on one side of the inverter housing in the axial direction and extending in the radial direction with respect to the central axis; and
the base plate is fixed to the bottom portion of the motor housing of the motor.

13: The electric oil pump according to claim 12, wherein the base plate has a plate shape, extends in a direction along an end surface of the inverter housing on one side in the axial direction, covers the end surface, and is welded to the bottom portion of the motor housing.

14: The electric oil pump according to claim 12, wherein
the base plate has an L shape extending inward from an outward side of an end surface in the radial direction along an end surface of an inverter housing extension portion on one side in the axial direction that extends to an outward side of the motor housing of inverter housing in the radial direction, and is bent to one side in the axial direction along an outer surface of the motor housing on the other side in the axial direction;
a base plate extension portion that extends along the end surface of the inverter housing extension portion of the base plate is fixed to the inverter housing extension portion; and
a base plate body portion extending along the outer surface of the motor housing of the base plate on the other side in the axial direction is fixed to the outer surface.

15: The electric oil pump according to claim 12, wherein
the inverter housing and the base plate are integrally molded with a resin; and
the inverter housing is fixed to the bottom portion of the motor housing together with the base plate.

16: The electric oil pump according to claim 12, wherein
the base plate has an L shape extending inward from a radially outward side in the inverter housing and is bent along an outer surface of the motor housing on the other side in the axial direction;
the base plate and the inverter housing are integrally molded with a resin; and
a base plate body portion extending along the outer surface of the motor housing of the base plate on the other side in the axial direction is fixed to the outer surface.

17: The electric oil pump according to claim 13, wherein a base plate extension portion of the base plate extending to an outward side of the motor housing of the base plate in the radial direction and an inverter housing extension portion of the inverter housing with which the base plate extension portion is in contact are fixed.

18: The electric oil pump according to claim 14, wherein
the inverter housing is made of a resin;
the inverter housing extension portion includes a through hole penetrating therethrough in the axial direction to accommodate a fixing member;
a metal collar is inserted into the through hole; and
the inverter housing extension portion and the base plate extension portion are fixed by the fixing member via the collar.

19: The electric oil pump according to claim 15, wherein
a motor side end portion of the inverter housing includes an inverter housing fixing portion fixed to the bottom portion of the motor housing;
the motor housing is made of a metal;
the inverter housing is made of a resin;
the inverter housing fixing portion of the inverter housing includes a through hole penetrating therethrough in the axial direction to accommodate a fixing member;
a metal collar is inserted into the through hole; and
the inverter housing fixing portion and the bottom portion of the motor housing are fixed by the fixing member via the collar.

20: The electric oil pump according to claim 18, wherein a length of the collar in the axial direction is larger than that of the through hole in the axial direction.

21: The electric oil pump according to claim 19, wherein
the inverter housing fixing portion of the inverter housing includes a protruding portion protruding to a motor side;
the protruding portion includes a coil end through hole penetrating therethrough in the axial direction;
the motor housing includes an insertion hole, into which the protruding portion is inserted, in the bottom portion;
an end portion of the protruding portion on one side in the axial direction protrudes from an opening portion of the insertion hole on one side in the axial direction in a state in which the protruding portion is inserted into the insertion hole; and
a coil end extending from the motor passes through the coil end through hole and extends into the inverter.

22: The electric oil pump according to claim 21, wherein the fixing member and the coil end through hole are alternately disposed in the inverter housing fixing portion of the inverter housing in the circumferential direction with respect to the central axis.
